(19) United States
(12) Patent Application Publication
(10) Pub. No.: US 2025/0320350 A1
(43) Pub. Date: Oct. 16, 2025

(54) RUBBER FORMULATIONS YIELDING IMPROVED DYNAMIC PROPERTIES AND WEAR

(71) Applicants: Bridgestone Corporation, Tokyo (JP); Bridgestone Americas Tire Operations, LLC, Nashville, TN (US)

(72) Inventors: Terrence E. HOGAN, Uniontown, OH (US); Gabrielle L. McINTYRE, Akron, OH (US); Erin SHEEPWASH, Copley, OH (US); Rita E. COOK, Akron, OH (US); Anthony M. COFFMAN, Munroe Falls, OH (US)

(21) Appl. No.: 18/867,529

(22) PCT Filed: May 22, 2023
(86) PCT No.: PCT/US2023/023110

§ 371 Date: Nov. 20, 2024

Related U.S. Application Data
(60) Provisional application No. 63/344,189, filed on May 20, 2022.

(51) Int. Cl. C08L 9/06; B60C 1/00; C08K 3/06; C08L 9/00

(52) U.S. Cl. CPC C08L 9/06; C08K 3/06; C08L 9/00; B60C 1/0016; C08L 2205/025; C08L 2205/035; C08L 2207/324; C08L 2312/00

(57) ABSTRACT

A vulcanizable composition comprising (i) a base rubber component; (ii) a low molecular weight polydiene additive, where the low molecular weight polydiene additive is characterized by an Mn of less than 100 kg/mol, an Mw of less than 110 kg/mol, a Tg of greater than −30° C., and a vinyl content, relative to the diene mer units, of greater than 35 mol %; (iii) a filler; and (iv) a curative.

### FIELD OF THE INVENTION

Embodiments of the present invention provide rubber formulations and rubber vulcanizates, particularly those useful as tire treads, with improved wear and/or improved viscoelastic properties.

### BACKGROUND OF THE INVENTION

In the art of making tires, oils have historically been included in the rubber formulations to provide processing advantages. That is, by introducing oils into the rubber formation, the overall viscosity of the formulation can be lowered, which facilitates, among other things, the ability to mix the rubber formulation and disperse the various additives, such as reinforcing fillers and curatives, throughout the rubber formation. It is also known that certain oils can provide other advantages including improvement in one or more viscoelastic properties of the resulting vulcanizate.

While the inclusion of oil can offer several advantages to rubber formulations and the resulting vulcanizates, the skilled person also appreciates that the low molecular weight nature of oils can provide tradeoffs and disadvantages. For example, the skilled person understands that oils can have a deleterious impact on rolling resistance and tread wear.

### SUMMARY OF THE INVENTION

One or more embodiments of the present invention provide a vulcanizable composition comprising (i) a base rubber component; (ii) a low molecular weight polydiene additive, where the low molecular weight polydiene additive is characterized by an Mn of less than 100 kg/mol, an Mw of less than 110 kg/mol, a Tg of greater than −30° C., and a vinyl content, relative to the diene mer units, of greater than 35 mol %; (iii) a filler; and (iv) a curative.

Yet other embodiments of the present invention provide a vulcanizate prepared by subjecting the vulcanizable composition of any of the preceding claims to curing conditions.

Still other embodiments of the present invention provide a method of preparing a vulcanizate, the method comprising subjecting the vulcanizable composition of any of the preceding claims to curing conditions.

### DETAILED DESCRIPTION OF ILLUSTRATIVE EMBODIMENTS

Embodiments of the invention are based, at least in part, on the discovery of a rubber formulation that includes a low molecular weight polydiene additive. The rubber formulations, which are useful in the manufacture of tires, particularly tire treads, provides rubber vulcanizates that are characterized by improvements in at least one of viscoelastic properties and wear. For example, the improved viscoelastic properties may include increased tan δ at 0° C., which is believed to be indicative of improved wet traction, and decreased tan δ at 65° C., which is believed to be indicative of improved rolling resistance relative to comparative vulcanizates prepared in the absence of the low molecular weight polydiene polymer additive. According to embodiments of the invention, the low molecular weight polydiene additive is a polymer characterized by a relatively low molecular weight and a relatively high glass transition temperature. In certain embodiments, the rubber formulations include less than threshold amounts of oil because the low molecular weight polydiene additive can advantageously serve as a replacement for at least a portion of the oil that would otherwise be required to allow processing of the rubber formulation.

### Rubber Formulation

The rubber formulations of the present invention, which may also be referred to as vulcanizable compositions, include a base rubber component, a low molecular weight polydiene additive, a filler, and a curative. The compositions may also optionally include other ingredients including, but not limited to, waxes, antidegradants, oils, solid resins, liquid resins, and cure accelerators.

### Low Molecular Weight Polydiene Additive

According to embodiments of this invention, the low molecular weight polydiene additive, which may also be referred to as a low molecular weight additive or LMW polydiene additive or simply the additive, is a polydiene homopolymer or a polydiene copolymer. As the skilled person appreciates, the term polydiene refers to a synthetic polymer or copolymer that is prepared by polymerization of one or more types of conjugated diene monomer optionally together with one or more types of vinyl aromatic monomer. Exemplary conjugated diene monomer may include, but is not limited to, 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene. Exemplary vinyl aromatic monomer may include, but is not limited to, styrene, p-methylstyrene, α-methylstyrene, and vinylnaphthalene. Exemplary low molecular weight polydiene additives may include, but are not limited to, polybutadiene, polyisoprene, poly(butadiene-co-isoprene), poly(styrene-co-butadiene), poly(styrene-co-isoprene), poly(styrene-co-butadiene-isoprene).

As indicated above, the LMW polydiene additive is characterized by a relatively low molecular weight including relatively low number average molecular weight (Mn) and relatively low weight average molecular weight (Mw). According to embodiments of the present invention, molecular weight moments (e.g. Mn and Mw) can be determined by gel permeation chromatography (GPC) using polystyrene standards. In one or more embodiments, the LMW polydiene additive has an Mn of less than 100 kg/mol, in other embodiments less than 90 kg/mol, in other embodiments less than 80 kg/mol, and in other embodiments less than 70 kg/mol. In these or other embodiments, the LMW polydiene additive has an Mn of greater than 10 kg/mol, in other embodiments greater than 20 kg/mol, in other embodiments greater than 30 kg/mol, in other embodiments greater than 40 kg/mol, in other embodiments greater than 50 kg/mol, in other embodiments greater than 60 kg/mol, and in other embodiments greater than 70 kg/mol. In one or more embodiments, the LMW polydiene additive has an Mn of from about 10 to about 100, in other embodiments from about 20 to about 90, in other embodiments from about 30 to about 80, in other embodiments from about 50 to about 95, in other embodiments from about 60 to about 90, and in other embodiments from about 40 to about 70 kg/mol.

In one or more embodiments, the LMW polydiene additive has an Mw of less than 110 kg/mol, in other embodiments less than 100 kg/mol, in other embodiments less than 90 kg/mol, and in other embodiments less than 80 kg/mol. In these or other embodiments, the LMW polydiene additive has an Mw of greater than 10 kg/mol, in other embodiments greater than 20 kg/mol, in other embodiments greater than 30 kg/mol, and in other embodiments greater than 40 kg/mol. In one or more embodiments, the LMW polydiene additive has an Mw of from about 10 to about 110, in other embodiments from about 20 to about 100, in other embodiments from about 30 to about 90, and in other embodiments from about 40 to about 80 kg/mol.

In one or more embodiments, the LMW polydiene additive may be characterized by a molecular weight distribution (Mw/Mn) of less than 3, in other embodiments less than 2.5, in other embodiments less than 2, and in other embodiments less than 1.5.

As indicated above, the LMW polydiene additive is characterized by a relatively high glass transition temperature (Tg). According to embodiments of the present invention, Tg can be determined by using differential scanning calorimetry (DSC) at 10° C./min. In one or more embodiments, the LMW polydiene additive has Tg of greater than −30° C., in other embodiments greater than −25° C., in other embodiments greater than −20° C., and in other embodiments greater than −15° C. In these or other embodiments, the LMW polydiene additive has a Tg of less than 30° C., in other embodiments less than 20° C., in other embodiments less than 10° C., and in other embodiments less than 0° C. In one or more embodiments, the LMW polydiene additive has at Tg of from about −30 to about 30, in other embodiments from about −25 to about 25, in other embodiments from about −20 to about 20, and in other embodiments from about −15 to about 5° C.

The LMW polydiene additive employed in the present invention may be further characterized by the vinyl content of the diene mer units of the copolymer. According to embodiments of the present invention, vinyl content can be determined by FTIR including FTIR coupled to GPC. As the skilled person appreciates, the vinyl content of an LMW polydiene is represented as a mole percentage relative to the mole of butadiene mer units within the copolymer. In one or more embodiments, the LMW polydiene additive has vinyl content of greater than 35 mol %, in other embodiments greater than 40 mol %, in other embodiments greater than 45 mol %, and in other embodiments greater than 50 mol %. In these or other embodiments, the LMW polydiene additive has a vinyl content of less than 75 mol %, in other embodiments less than 70 mol %, in other embodiments less than 65 mol %, and in other embodiments less than 60 mol %. In one or more embodiments, the LMW polydiene additive has a vinyl content of from about 35 to about 75 mol %, in other embodiments from about 40 to about 70 mol %, in other embodiments from about 45 to about 65 mol %, and in other embodiments from about 50 to about 60 mol %.

In those embodiments where the LMW polydiene additive includes mer units deriving from polymer of vinyl aromatic monomer, the LMW polydiene additive may be further characterized by the bound styrene content of the copolymer. According to embodiments of the present invention, bound styrene can be determined by FTIR including FTIR coupled to GPC. As the skilled person appreciates, the bound styrene (i.e. bound vinyl aromatic monomer) content is represented as a weight percentage relative to the total weight of the copolymer. In one or more embodiments, the LMW polydiene additive has bound styrene content of greater than 20 wt %, in other embodiments greater than 25 wt %, in other embodiments greater than 30 wt %, and in other embodiments greater than 35 wt %. In these or other embodiments, the LMW polydiene additive has a bound styrene content of less than 65 wt %, in other embodiments less than 60 wt %, in other embodiments less than 55 wt %, and in other embodiments less than 50 wt %. In one or more embodiments, the LMW polydiene additive has a bound styrene content of from about 20 to about 65 wt %, in other embodiments from about 25 to about 60 wt %, in other embodiments from about 30 to about 55 wt %, and in other embodiments from about 35 to about 50 wt %.

### Base Rubber

As indicated above, the rubber formulations of the invention include a base rubber, which may also be referred to as a base rubber component. The base rubber component may generally include an elastomeric polymer, which may also be referred as a vulcanizable rubber, a rubber polymer, elastomers, or simply a rubber. Elastomeric polymers include those polymers that can be vulcanized. The elastomeric polymers may be synthetic and/or natural. The synthetic elastomeric polymers, which may be referred to as synthetic polymers or synthetic elastomers, may include polydienes and polydiene copolymers. Specific examples of these synthetic polymers include, but are not limited to, polybutadiene, poly(styrene-co-butadiene), polyisoprene, poly(styrene-co-isoprene), poly(styrene-co-isoprene-butadiene), and functionalized derivatives thereof. Other polymers that may be included in the base rubber include neoprene, poly(ethylene-co-propylene), poly(styrene-co-butadiene), poly(ethylene-co-propylene-co-diene), polysulfide rubber, acrylic rubber, urethane rubber, silicone rubber, epichlorohydrin rubber, syndiotactic polybutadiene, and mixtures thereof or with polydienes and polydiene copolymers. These synthetic polymers can have a myriad of macromolecular structures including linear, branched, and star-shaped structures. These synthetic polymers may also include one or more functional units, which typically include heteroatoms tethered to the backbone of the polymer. Blends of natural rubber and one synthetic rubber may be used. In other embodiments, blends of natural rubber and two or more synthetic rubbers may be used. In other embodiments, blends of two or more synthetic rubbers may be used in the absence of natural rubber.

In one or more embodiments, the synthetic polymers that make up the base polymer component of the rubber formulations of the invention include relatively high molecular weight polymers, which are elastomer polymers characterized by a relatively high molecular weight relative to the LMW polydiene additive. The skilled person understand that the molecular weight can be quantified by number average molecular weight (Mn) and weight average molecular weight (Mw). According to embodiments of the present invention, molecular weight moments (e.g. Mn and Mw) can be determined by gel permeation chromatography (GPC) using polystyrene standards.

In one or more embodiments, the base polymers (e.g. the synthetic polymers) have an Mn of greater than 110 kg/mol, in other embodiments greater than 130 kg/mol, in other embodiments greater than 150 kg/mol, and in other embodiments greater than 170 kg/mol. In these or other embodiments, the base polymers have an Mn of from about 110 to above 1,000 kg/mol, in other embodiments from about 130 to about 800 kg/mol, in other embodiments from about 150 to about 600 kg/mol, and in other embodiments from about 170 to about 400 kg/mol.

In one or more embodiments, the base polymers (e.g. the synthetic polymers) have an Mw of greater than 120 kg/mol, in other embodiments greater than 160 kg/mol, in other embodiments greater than 200 kg/mol, and in other embodiments greater than 240 kg/mol. In these or other embodiments, the base polymers have an Mw of from about 120 to above 1,000 kg/mol, in other embodiments from about 160 to about 950 kg/mol, in other embodiments from about 200 to about 800 kg/mol, and in other embodiments from about 240 to about 700 kg/mol.

In one or more embodiments, the base polymers (e.g. the synthetic polymers) may be characterized by a molecular weight distribution (Mw/Mn) of less than 5, in other embodiments less than 4, in other embodiments less than 3, and in other embodiments less than 2.

In one or more embodiments, the base polymers (e.g. the synthetic polymers) are characterized by their glass transition temperature (Tg). According to embodiments of the present invention, Tg can be determined by using differential scanning calorimetry (DSC) at 10° C./min. In one or more embodiments, the base polymers have Tg of greater than −110° C., in other embodiments greater than −80° C., in other embodiments greater than −70° C., and in other embodiments greater than −60° C. In these or other embodiments, the base polymers have a Tg of less than −20° C., in other embodiments less than −30° C., in other embodiments less than −35° C., and in other embodiments less than −40° C. In one or more embodiments, the base polymers have a Tg of from about −110 to about −20° C., in other embodiments from about −80 to about −30° C., in other embodiments from about −70 to about −35° C., and in other embodiments from about −60 to about −40° C.

### Filler

As suggested above, the vulcanizable compositions can include a filler such as reinforcing filler. Filler include, but are not limited to, carbon black and silica.

In one or more embodiments, useful carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In one or more embodiments, suitable silica fillers include precipitated amorphous silica, wet silica (hydrated silicic acid), dry silica (anhydrous silicic acid), fumed silica, calcium silicate, aluminum silicate, calcium aluminum silicate, magnesium silicate, and the like.

In one or more embodiments, the surface area of the silica, as measured by the BET method, may be from about 32 to about 400 m²/g (including 32 m²/g to 400 m²/g), with the range of about 100 m²/g to about 300 m²/g (including 100 m²/g to 300 m²/g) being preferred, and the range of about 150 m²/g to about 220 m²/g (including 150 m²/g to 220 m²/g) being included. In one or more embodiments, the silica may be characterized by a pH of about 5.5 to about 7 or slightly over 7, or in other embodiments from about 5.5 to about 6.8. Some of the commercially available silica fillers that can be used include, but are not limited to, those sold under the tradename Hi-Sil, such as 190, 210, 215, 233, and 243, by PPG Industries, as well as those available from Degussa Corporation (e.g., VN2, VN3), Rhone Poulenc (e.g., Zeosil™ 1165 MP), and J. M. Huber Corporation.

In one or more embodiments, silica coupling agents are included in the vulcanizable composition. As the skilled person appreciates, these compounds include a hydrolyzable silicon moiety (often referred to as a silane) and a moiety that can react with a vulcanizable polymer.

Suitable silica coupling agents include, for example, those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition.

Non-limiting examples of alkyl alkoxysilanes suitable for use in certain embodiments of the fourth embodiment disclosed herein include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano)polysulfides suitable for use in certain embodiments of the fourth embodiment disclosed herein include bis(trialkoxysilylorgano) disulfides and bis(trialkoxysilylorgano)tetrasulfides. Specific non-limiting examples of bis(trialkoxysilylorgano)disulfides suitable for use in certain exemplary embodiments of the fourth embodiment disclosed herein include, but are not limited to, 3,3′-bis(triethoxysilylpropyl) disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis(trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof. Non-limiting examples of bis(trialkoxysilylorgano)tetrasulfide silica coupling agents suitable for use in certain embodiments of the fourth embodiment disclosed herein include, but are not limited to, bis(3-triethoxysilylpropyl)tetrasulfide, bis(2-triethoxysilylethyl) tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl)tetrasulfide is sold under the tradename Si69 by Evonik Degussa Corporation.

Non-limiting examples of mercapto silanes suitable for use in certain embodiments of the fourth embodiment disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiment of the fourth embodiment disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes for use herein in certain exemplary embodiments disclosed herein include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldiethoxysilylmethylthioacetate; methyldimethoxysilylmethylthioacetate; methyldiisopropoxysilylmethylthioacetate; dimethylethoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilyl methyl methylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is that sold under the tradename NXT silane (3-octanoylthio-1-propyltriethoxysilane) by Momentive Performance Materials Inc.

### Oils

As suggested above, the vulcanizable compositions may optionally include oil. In one or more embodiments, oils include those organic-based materials that have an absolute viscosity of less than 10,000 cP, in other embodiments less than 5,000 cP, and in other embodiments less than 2,500 cP at standard conditions of temperature and pressure. As is generally understood in the art, oils refer to those compounds that have a viscosity that is relatively low compared to other constituents of the vulcanizable composition, such as the resins. Exemplary oils include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil.

### Solid Resins

As suggested above, the vulcanizable compositions may include resin. In one or more embodiments, the resins may be solids with a Tg of greater than 20° C., in other embodiments greater than 30° C., in other embodiments greater than 40° C., and in other embodiments greater than 50° C. Resin may include, but are not limited to, hydrocarbon resins such as cycloaliphatic resins, aliphatic resins, aromatic resins, terpene resins, and combinations thereof. Useful resins include, but are not limited to, styrene-alkylene block copolymers, thermoplastic resins such as C5-based resins, C5-C9-based resins, C9-based resins, terpene-based resins, terpene-aromatic compound-based resins, rosin-based resins, dicyclopentadiene resins, alkylphenol-based resins, and their partially hydrogenated resins.

### Curative

As suggested above, the rubber formulations include a curative. In one or more embodiments, the vulcanizable compositions of this invention include a cure system. The cure system includes a curative, which may also be referred to as a crosslinking agent, rubber curing agent or vulcanizing agents. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. In one or more embodiments, useful cure systems include sulfur or sulfur-based cross-linking agents, organic peroxide-based crosslinking agents, inorganic crosslinking agents, polyamines crosslinking agents, resin crosslinking agents, oxime-based and nitrosamine-based cross-linking agents, and the like. Examples of suitable sulfur crosslinking agents include “rubbermaker's” soluble sulfur; sulfur donating vulcanizing agents, such as an amine disulfide, polymeric polysulfide or sulfur olefin adducts; and insoluble polymeric sulfur. In other embodiments, the crosslinking agents include sulfur and/or sulfur-containing compounds. In other embodiments, the crosslinking agent excludes sulfur and/or sulfur-containing compounds. Vulcanizing agents may be used alone or in combination.

### Other Ingredients

Other ingredients that are typically employed in rubber compounding may also be added to the rubber compositions. These include accelerators, accelerator activators, additional plasticizers, waxes, scorch inhibiting agents, processing aids, zinc oxide, tackifying resins, reinforcing or hardening resins, fatty acids such as stearic acid, peptizers, and antidegradants such as antioxidants and antiozonants.

### Ingredient Loading

### LMW Polydiene Additive

In one or more embodiments, the rubber formulations of this invention include greater than 8 parts by weight (pbw), in other embodiments greater than 12 pbw, in other embodiments greater than 14 pbw, and in other embodiments greater than 16 pbw of the low molecular weight polydiene additive per one hundred parts by weight of the rubber component (phr), which rubber component does not include the low molecular weight polydiene additive. In these or other embodiments, the rubber formulations include less than 50 parts by weight (pbw), in other embodiments less than 40 pbw, in other embodiments less than 35 pbw, and in other embodiments less than 30 pbw of the low molecular weight polydiene additive phr. In one or more embodiments, the rubber formulations include from about 8 to about 50, in other embodiments from about 12 to about 40, in other embodiments from about 14 to about 35, and in other embodiments from about 16 to about 30 pbw of the low molecular weight polydiene additive phr.

### Base Rubber

In one or more embodiments, the rubber formulations of this invention include greater than 25 wt %, in other embodiments greater than 30 wt %, and in other embodiments greater than 35 wt % of the base rubber based upon the total weight of the formulation. In these or other embodiments, the rubber formulation includes less than 80 wt %, in other embodiments less than 70 wt %, and in other embodiments less than 60 wt % of the base rubber based upon the total weight of the rubber formulation. In one or more embodiments, the rubber formulations include from about 25 to about 80 wt %, in other embodiments from about 30 to about 70 wt %, and in other embodiments from about 35 to about 60 wt % of the base rubber based upon the total weight of the rubber formulation. The skilled person will appreciate that the amount of rubber (as well as the other constituents of the vulcanizate) will correspond to the amount of the rubber and rubber additives included in the vulcanizable composition.

In one or more embodiments, the base rubber includes greater than 5 wt %, in other embodiments greater than 10 wt %, and in other embodiments greater than 15 wt % natural rubber based upon the total weight of the base rubber. In these or other embodiments, the rubber includes less than 40 wt %, in other embodiments less than 35 wt %, and in other embodiments less than 25 wt % natural rubber based upon the total weight of the base rubber. In one or more embodiments, the base rubber includes from about 5 to about 40 wt %, in other embodiments from about 10 to about 35 wt %, and in other embodiments from about 15 to about 25 wt % natural rubber based upon the total weight of the base rubber. In one or more embodiments, the base rubber may be devoid or substantially devoid of natural rubber.

### Oils

In one or more embodiments, the rubber formulations include greater than 0, in other embodiments greater than 3, and in other embodiments greater than 5 pbw oils and liquid plasticizers phr. In these or other embodiments, the rubber formulations may include less than 20, in other embodiments less than 15, in other embodiments less than 10, and in other embodiments less than 8 pbw oils phr. In one or more embodiments, vulcanizable compositions may include from 0 to about 20, in other embodiments from about 3 to about 15, and in other embodiments from about 5 to about 8 pbw oils phr. In certain embodiments, the vulcanizable compositions are devoid of oils.

### Solid Resins

In one or more embodiments, the rubber formulations include greater than 0, in other embodiments greater than 3, and in other embodiments greater than 5 pbw solid plasticizers phr. In these or other embodiments, the rubber formulations may generally include less than 20, in other embodiments less than 15, in other embodiments less than 10, and in other embodiments less than 8 pbw solid plasticizers phr. In one or more embodiments, vulcanizable compositions may include from 0 to about 20, in other embodiments from about 3 to about 15, and in other embodiments from about 5 to about 8 pbw solid plasticizers phr. In certain embodiments, the vulcanizable compositions are devoid of solid plasticizer.

### Fillers

In one or more embodiments, the rubber formulations include a filler such as carbon black or silica. In one or more embodiments, the rubber formulations include greater than 10 pbw, in other embodiments greater than 35 pbw, and in other embodiments greater than 55 pbw filler (e.g. carbon black and or silica) per one hundred parts by weight of the base rubber (phr). In these or other embodiments, the rubber formulations include less than 140 pbw, in other embodiments less than 95 pbw, and in other embodiments less than 75 pbw filler phr. In one or more embodiments, the rubber formulations include from about 10 to about 200 pbw, in other embodiments from about 10 to about 140 pbw, in other embodiments from about 35 to about 95 pbw, in other embodiments from about 40 to about 130 pbw, in other embodiments from about 50 to about 120 pbw, and in other embodiments from about 55 to about 75 pbw filler (e.g. carbon black and or silica) phr. Carbon black and silica may be used in conjunction at a weight ratio of silica to carbon black of from about 0.1:1 to about 30:1, in other embodiments of from about 0.5 to about 20:1, and in other embodiments from about 1:1 to about 10:1.

In one or more embodiments, where silica is used as a filler, the rubber formulations may include silica coupling agent. In one or more embodiments, the rubber formulations may include greater than 1, in other embodiments greater than 2, and in other embodiments greater than 3 pbw silica coupling agent phr. In these or other embodiments, the rubber formulations may include less than 40, in other embodiments less than 20, and in other embodiments less than 10 pbw silica coupling agent phr. In one or more embodiments, the rubber formulations include from about 1 to about 40 pbw, in other embodiments from about 2 to about 20 pbw, in other embodiments from about 2.5 to about 15 pbw, and in other embodiments from about 3 to about 10 pbw silica coupling agent phr.

In these or other embodiments, the amount of silica coupling agent may be defined relative to the weight of the silica. In one or more embodiments, the amount of silica coupling agent introduced to the silica (either in situ or pre-reacted) is from about 1 to about 25 pbw, in other embodiments from about 2 to about 20 pbw, and in other embodiments from about 3 to about 15 pbw silica coupling agent per one hundred parts by weight of the silica.

### Vulcanizing Agents

The skilled person will be able to readily select the amount of vulcanizing agents to achieve the level of desired cure. In particular embodiments, sulfur is used as the cure agent. In one or more embodiments, the vulcanizable compositions may include greater than 0.5, in other embodiments greater than 1, and in other embodiments greater than 2 pbw sulfur phr. In these or other embodiments, the vulcanizable compositions may generally include less than 10, in other embodiments less than 7, and in other embodiments less than 5 pbw sulfur phr. In one or more embodiments, the vulcanizable compositions may generally include from about 0.5 to about 10, in other embodiments from about 1 to about 6, and in other embodiments from about 2 to about 4 pbw sulfur phr.

### Preparation of Vulcanizate

In one or more embodiments, the vulcanizate is prepared by vulcanizing a vulcanizable composition, which includes the elastomeric polymers and low molecular weight polydiene additives defined herein. The vulcanizable compositions are otherwise prepared using conventional mixing techniques. The vulcanizable composition is then formed into a green vulcanizate and then subjected to conditions to effect curing (i.e. crosslinking) of the polymeric network. For example, all ingredients of the vulcanizable compositions can be mixed with standard mixing equipment such as Banbury or Brabender mixers, extruders, kneaders, and two-rolled mills. In one or more embodiments, this may include a multi-stage mixing procedure where the ingredients are introduced and/or mixed in two or more stages. For example, in a first stage (which is often referred to as a masterbatch mixing stage), the elastomer (including functionalized polymers of this invention), filler and optional ingredients are mixed. In one or more embodiments, where a silica functionalizing agent pursuant to this invention (i.e. including hydrogen-bonding functionalities) is included in the vulcanizable composition, the silica functionalizing agent is added in one or more masterbatch stages. Likewise, where a silica coupling agent (i.e. conventional type silica coupling agent) is used, either alone or in conjunction with the silica functionalizing agent, it too may be added during one or more masterbatch stages. Generally speaking, masterbatch mixing steps include those steps where an ingredient is added and mixing conditions take place at energies (e.g. temperature and shear) above that which would scorch the composition in the presence of a curative. Similarly, re-mill mixing stages take place at the same or similar energies except an ingredient is not added during a re-mill mixing stage. It is believed that the energies imparted to the vulcanizable composition during masterbatch or re-mill mixing is sufficient to disperse the filler and to cause hydrolysis and subsequent condensation of the hydrolyzable groups. For example, it is believed that during one or more of these mix stages, the hydrolyzable groups of the silica functionalizing agents hydrolyze and then, via a condensation reaction, bond to the silica particles. To this end, in one or more embodiments, masterbatch or re-mill mixing may take place in presence of a catalyst that serves to promote the reaction between the hydrolyzable groups and the silica (e.g. between the silica functionalizing agent and the silica or between the silica coupling agent and the silica). These catalysts are generally known in the art and include, for example, strong bases such as, but not limited to, alkali metal alkoxides, such as sodium or potassium alkoxide; guanidines, such as triphenylguanidine, diphenylguanidine, di-o-tolylguanidine, N,N,N′,N′-tetramethylguanidine, and the like; and hindered amine bases, such as 1,8-diazabicyclo[5.4.0]undec-7-ene, 1,5-diazabicyclo[4.3.0]non-5-ene, and the like, tertiary amine catalysts, such as N,N-dimethylcyclohexylamine, triethylenediamine, triethylamine, and the like, quaternary ammonium bases, such as tetrabutylammonium hydroxide, and bisaminoethers, such as bis(dimethylaminoethyl)ethers.

Accordingly, masterbatch and re-mill mixing takes place in the absence of the curative and proceed at temperatures above which the curing would otherwise take place if the curative was present. For example, this mixing can take place at temperatures in excess of 120° C., in other embodiments in excess of 130° C., in other embodiments in excess of 140° C., and in other embodiments in excess of 150° C.

In one or more embodiments, the low molecular weight additive can be introduced to the rubber formulation together with the other masterbatch ingredients. In other embodiments, the low molecular weight additive can be introduced to the rubber formulation alone or together with other re-mill ingredients after masterbatch mixing. In other embodiments, a portion of the low molecular weight additive can be introduced to the rubber formulation together with the masterbatch ingredients and a portion can be introduced after masterbatch mixing (e.g. as part of the re-mill).

Once the masterbatch is prepared, the vulcanizing agents may be introduced and mixed into the masterbatch in a final mixing stage, which is typically conducted at relatively low temperatures so as to reduce the chances of premature vulcanization. For example, this mixing may take place at temperatures below 120° C., in other embodiments below 110° C., in other embodiments below 100° C. Additional mixing stages, sometimes called remills, can be employed between the masterbatch mixing stage and the final mixing stage.

During the curing process, covalently bonds are formed between the polymer chains and optionally between one or more of the other constituents of the rubber formulation. In one or more embodiments, a sulfur-based cure system is employed. With regard to the low molecular weight polydiene additive, covalent bonds (i.e. crosslinks) may be formed between the base polymer and the low molecular weight polydiene additive.

### INDUSTRIAL APPLICABILITY

The vulcanizates of the present invention are useful in tire components. This may include use in tire treads, sidewalls, body plies, inner liners, bead fillers, and abrasion strips. The vulcanizable compositions can be processed into tire components according to ordinary tire manufacturing techniques including standard rubber shaping, molding and curing techniques.

In order to demonstrate the practice of the present invention, the following examples have been prepared and tested. The examples should not, however, be viewed as limiting the scope of the invention. The claims will serve to define the invention.

### EXAMPLES

### Experimental Section

Vulcanizable compositions were prepared using the rubber formulation and mixing order provided in Table I. This rubber formulation was indicative of a rubber formulation that is useful in the manufacture of tire treads. As shown in Table I, the mix procedure was a three-step mix procedure including a masterbatch mix step, a “remill mix step,” and a final mix step. The various mixing steps were performed within a Banbury mixer. During preparation of the masterbatch, the mixer was operated at 75 rpm and a peak compositional temperature of 160° C. was attained. At that point in time, the composition was dropped from the mixer and allowed to cool to below about 85° C. At this point in time, the composition was then reintroduced to the mixer along with the ingredients identified for the “remill stage,” and mixing was continued at 75 rpm and a peak compositional temperature of about 160° C. was achieved. The composition was again dropped from the mixer and allowed to cool to below about 50° C. Then, the composition was again reintroduced to the mixer along with the ingredients identified for the “final mix stage.”

As should be evident from Table I, the amount of oil and low molecular weight polydiene additive, which are listed as variable, were changed in the various samples. It should also be appreciated that the oil and low molecular weight polydiene additive were included, in at least some of the Samples, within both the masterbatch step and the remill step. The exact amounts used in each Sample are provided in Table II along with the results of mechanical and dynamic testing that was performed on the rubber formulations or resulting vulcanizates.

TABLE I

| | |
|---|---|
| Ingredient | phr |

Master

| | |
|---|---|
| Natural Rubber | 20 |
| Synthetic Rubber | 80 |
| Wax | 2 |
| Silica Coupling Agent | 5 |
| Silica | 50 |
| Carbon Black | 7 |
| Oil | variable |
| LMW Polydiene Additive | variable |

Remill

| | |
|---|---|
| Stearic Acid | 2 |
| Antidegradant | 1.3 |
| LMW Polydiene Additive | variable |
| Black Oil | variable |
| Si75 | 4.0 |
| Silica | 41 |

Final

| | |
|---|---|
| Zinc Oxide | 2.5 |
| DPG | 2 |
| MBTS | 0.75 |
| Santocure NS | 1.25 |
| Sulfur | 1.5 |

With regard to the data in Table II, rheometer measurements were taken using an MDR 2000 operating at temperatures as specified in the Tables. The tensile mechanical properties (e.g. max stress, modulus, elongation, and toughness) of the vulcanizates were measured by using the standard procedure described in ASTM-D412. The dynamic rheological properties (e.g. tan S) of the vulcanizates were obtained from temperature sweep studies that were conducted over the range from about −80° C. to about 80° C. and 10 Hz and strain sweep studies that were conducted over the range from 0.05 to about 7.5% strain with increments of 0.25%.

Also, it should be appreciated that the base rubber component included 20 parts by weight of natural rubber and 80 parts by weight of a synthetic rubber. The type of synthetic rubber employed was varied throughout the Samples as shown in Table II. SBR I was poly(styrene-co-butadiene) characterized by an Mn of about 545 kg/mol, an Mw of about 814 kg/mol, a Tg of about −34° C., a vinyl content of about 60 mol %, and a bound styrene content of about 20 wt %. SBR II was poly(styrene-co-butadiene) characterized by an Mn of about 199 kg/mol, an Mw of about 264 kg/mol, a Tg of about −40° C., a vinyl content of about 26 mol %, and a bound styrene content of about 38 wt %. PB I was poly(butadiene) characterized by an Mn of about 193 kg/mol, an Mw of about 204 kg/mol, an a Tg of about −91° C., and a vinyl content of about 15 mol %. PB II was poly(butadiene) characterized by an Mn of about 206 kg/mol, an Mw of about 513 kg/mol, a Tg of about −109, and a vinyl content of about 1 mol %.

Further, the LMW polydiene additive employed in these Samples included a poly(styrene-co-butadiene) random copolymer characterized by an Mn of 92.5 kg/mol, an Mw of 102.1 kg/mol, a bound styrene of 38.3 wt %, a vinyl content of 54.3 mol % (in the butadiene portion) and a Tg of −1.5° C.

TABLE II

| | | | | | | | | |
|---|---|---|---|---|---|---|---|---|
| Sample | 1 | 2 | 3 | 4 | 5 | 6 | 7 | 8 |

Master

| | | | | | | | | |
|---|---|---|---|---|---|---|---|---|
| SBR Additive | 8 | 0 | 8 | 0 | 8 | 0 | 8 | 0 |
| Oil | 8 | 16 | 8 | 16 | 8 | 16 | 8 | 16 |

Remill

| | | | | | | | | |
|---|---|---|---|---|---|---|---|---|
| SBR Additive | 10 | 0 | 10 | 0 | 10 | 0 | 10 | 0 |
| Oil | 0 | 10 | 0 | 10 | 0 | 10 | 0 | 10 |
| Synthetic Elastomer | SBR I | SBR I | PB I | PB I | SBR II | SBR II | PB II | PB II |
| Cmpd ML/4 @ 100° C. | 151 | 120 | 156 | 130 | 112 | 82 | 181 | 178 |
| Tensile (MPa) | 13.2 | 12.9 | 14.7 | 12.4 | 15.4 | 15.3 | 12.4 | 12.3 |
| 300% Modulus (MPa) | 14.4 | — | 10.5 | 10.0 | 12.9 | 12.3 | 11.8 | 10.9 |
| Elongation (%) | 183 | 177 | 395 | 361 | 350 | 363 | 314 | 338 |

Stain Sweep @ 65° C.

| | | | | | | | | |
|---|---|---|---|---|---|---|---|---|
| Δ G′ | 127 | 131 | 153 | 157 | 119 | 102 | 139 | 141 |

Temperature Sweep @ 10 Hz

| | | | | | | | | |
|---|---|---|---|---|---|---|---|---|
| tan δ @ 0° C. | 0.436 | 0.420 | 0.272 | 0.222 | 0.402 | 0.428 | 0.247 | 0.212 |
| G′, MPa @ 30° C. | 249 | 185 | 247 | 199 | 249 | 156 | 218 | 166 |
| tan δ @ 30° C. | 0.233 | 0.254 | 0.206 | 0.176 | 0.240 | 0.288 | 0.197 | 0.173 |
| tan δ @ 65° C. | 0.167 | 0.185 | 0.159 | 0.149 | 0.178 | 0.212 | 0.162 | 0.152 |

Various modifications and alterations that do not depart from the scope and spirit of this invention will become apparent to those skilled in the art. This invention is not to be duly limited to the illustrative embodiments set forth herein.

1. A vulcanizable composition comprising:
(i) a base rubber component;
(ii) a low molecular weight polydiene additive, where the low molecular weight polydiene additive is characterized by an Mn of less than 100 kg/mol, an Mw of less than 110 kg/mol, a Tg of greater than −30° C., and a vinyl content, relative to the diene mer units, of greater than 35 mol %;
(iii) a filler; and
(iv) a curative.

2. The vulcanizable composition of claim 1, where the base rubber component includes from about 5 to about 40 wt % natural rubber based upon the total weight of the base rubber component, with the balance including a synthetic elastomer.

3. The vulcanizable composition of claim 1, where the vulcanizable composition includes from about 25 to about 80 wt % base rubber component based on the entire weight of the composition.

4. The vulcanizable composition of claim 2, where the synthetic elastomer is characterized by an Mn of greater than 110 kg/mol.

5. The vulcanizable composition of claim 4, where the synthetic elastomer is characterized by an Mw of greater than 120 kg/mol.

6. The vulcanizable composition of claim 2, where the synthetic elastomer of the base rubber component is characterized by a Tg of less than −20° C.

7. The vulcanizable composition of claim 2, where the synthetic elastomer of the base rubber component is selected from the group consisting of polybutadiene, poly(styrene-co-butadiene), polyisoprene, poly(styrene-co-isoprene), poly(styrene-co-isoprene-butadiene), or functionalized derivatives thereof.

8. The vulcanizable composition of claim 1, where the filler includes silica.

9. The vulcanizable composition of claim 1, where the low molecular weight polydiene additive is further characterized by a bound styrene content of greater than 20 wt %.

10. The vulcanizable composition of claim 1, where the low molecular weight polydiene copolymer is selected from the group consisting of poly(styrene-co-butadiene), poly(styrene-co-isoprene-co-butadiene), and poly(styrene-co-isoprene).

11. The vulcanizable composition of claim 1, where the vulcanizable composition includes from about 8 to about 50 parts by weight of the low molecular weight polydiene additive per one hundred parts by weight of the base rubber.

12. The vulcanizable composition of claim 1, where the vulcanizable composition further includes an oil.

13. The vulcanizable composition of claim 1, where the vulcanizable composition includes less than 20 parts by weight of oil per one hundred parts by weight base rubber.

14. The vulcanizable composition of claim 1, where the vulcanizable composition includes from about 10 to about 200 parts by weight filler per one hundred parts weight base rubber.

15. The vulcanizable composition of claim 1, where the vulcanizable composition includes a resin.

16. The vulcanizable composition of claim 1, where the vulcanizable composition includes less than 20 parts by weight resin per one hundred parts by weight base rubber.

17. The vulcanizable composition of claim 1, where the curative includes sulfur.

18. A vulcanizate prepared by subjecting the vulcanizable composition of claim 1 to curing conditions.

19. A method of preparing a vulcanizate, the method comprising subjecting the vulcanizable composition of claim 1 to curing conditions.

20. The method of claim 19, the method further comprising forming the vulcanizable composition into a green tire tread.
